(19) United States
(12) Patent Application Publication
(10) Pub. No.: US 2022/0036470 A9
(43) Pub. Date: Feb. 3, 2022

(54) METHOD OF PROVIDING PERSONAL ENGAGEMENT IN RECOVERY AND RETURN TO WORK FOR INDIVIDUALS ON DISABILITY INSURANCE

(71) Applicant: HARTFORD FIRE INSURANCE COMPANY, Hartford, CT (US)

(72) Inventors: Elizabeth G. Incze, Cumberland Foreside, ME (US); Paul W. Leach, Miami, FL (US); Keith L. Nelson, Parkland, FL (US); Michael G. Phidd, Rockville, MD (US); Michael J. Williams, Freeport, ME (US)

(21) Appl. No.: 17/123,909

(22) Filed: Dec. 16, 2020

Related U.S. Application Data
(63) Continuation of application No. 15/136,272, filed on Apr. 22, 2016, now abandoned.
(60) Provisional application No. 62/152,507, filed on Apr. 24, 2015.

(51) Int. Cl. G06Q 40/08; G06Q 10/10

(52) U.S. Cl. CPC G06Q 40/08; G06Q 10/10

(57) ABSTRACT

A user interface, system and method are described for assigning an insurance claim to a claim manager. The user interface allows teams of claim managers to he built so to efficiently process insurance claims as they are presented to a disability insurance carrier. The process of assigning the claim begins upon receiving an indication of a new insurance claim from a claim intake engine. Subsequently, the system determines the type of insurance claim based on metadata associated with the claim. Based on the metadata associated with the claim, a list of members in a team, of claim, managers is obtained, and a specific member is assigned as a claim manager for that claim.

### CROSS-REFERENCE TO RELATED APPLICATIONS

This application is a continuation of prior U.S. patent application Ser. No. 15/136,272 filed on Apr. 22, 2016, which claims the benefit of U.S. Provisional Patent Application No. 62/152,507, filed Apr. 24, 2015, each of which is incorporated by reference in its entirety.

### BACKGROUND

The disability insurance business is not nimble, and has not substantially changed since the early 1960's. Traditional benefits require a period of total disability, followed by benefits for two years if you are unable to perform the material duties of your own occupation no matter what your capabilities are for performing some level of productive work. As such, the industry needs to take into account significant improvements in healthcare, proven solutions for accommodating people with disabilities, and flexible workplace schedules including telework.

### BRIEF SUMMARY

One embodiment provides a system for processing a subscriber reported disability claim from a subscriber of a disability insurance carrier. The reported claim, data including subscriber reported medical conditions data. The system includes an interface configured for receiving the medical conditions data and converting said medical conditions data to first elements of first metadata. The system further includes at least one database configured to receive and store: (i) the first metadata; and (ii) a plurality of second metadata, each of the plurality of second metadata containing second elements representing assigned medical conditions that each of a plurality of claim managers are assigned for handling. The system further includes at least one server for electronically: accessing the first and second metadata; identifying, based on a comparison, at least one second metadata wherein all of the first elements are at least a subset of the second elements, thereby identifying one or more claim managers, of the plurality of claim managers, for handling each of the reported medical conditions; and based on a weighting analysis, assigning responsibility to one of the one or more claim managers for handling the disability claim on behalf of the disability insurance carrier. The server includes a processor and a memory. The processor is configured to execute computer-executable instructions stored in the memory to perform operations of: receiving notification of the medical conditions data being received at the interface; acquiring the first elements of the first metadata of the medical conditions data and the second elements of the second metadata from the database; comparing the first elements of the first metadata of the medical conditions data with the second elements of the second metadata to obtain a list of the one or more claim, managers capable of being assigned responsibility of the disability claim; filtering the list of the one or more claim managers capable of being assigned responsibility of the disability claim by determining which claim managers have capabilities most suitable to process the disability claim; selecting at least one individual claim manager to assign the disability claim from the filtered list of the one or more claim managers capable of being assigned responsibility of the disability claim; and assigning the at least, one individual claim manager as being responsible for the insurance claim by updating the first metadata stored in the database to reflect that the at least one individual claim manager is responsible for the disability claim.

Another embodiment provides a user interface for configuring a team of claim managers suitable for processing disability claims for a disability insurance carrier. The user interface includes a team configuration interface configured to add one or more claim managers to the team of claim managers or remove the one or more claim managers from the team of claim managers. The user interface also includes a claim manager capability assignment interface configured to specify capabilities of a selected claim manager from the team of claim managers. The user interface also includes a claim assignment data interface configured to specify an amount and type of insurance claims assigned to the selected claim manager from the team of claim managers and the user interface also includes a benefit authority interface configured to specify limitations on a monetary amount in benefits the selected claim manager can approve.

Yet another embodiment includes a method for processing a disability claim at a disability insurance carrier. The method includes: receiving medical condition data related to the disability claim; converting the medical condition data to first elements of first metadata and storing the first elements of the first metadata in a database; receiving notification of the medical conditions data being received at the interface; acquiring the first elements of the first metadata of the medical conditions data and second elements of second metadata representing previously stored assigned medical conditions that each of a plurality of claim managers are assigned for handling from the database; comparing the first elements of the first metadata of the medical condition data with the second elements of the second metadata to obtain a list of the one or more claim managers capable of being assigned responsibility of the disability claim; filtering the list of the one or more claim managers capable of being assigned responsibility of the disability claim by determining which claim managers have capabilities most suitable to process the disability claim; selecting at least one individual claim manager to assign the disability claim from the filtered list of the one or more claim managers capable of being assigned responsibility of the disability claim; and assigning the at least one individual claim manager as being responsible for the insurance claim by updating the first metadata stored in the database to reflect that the at least one individual claim manager is responsible for the disability claim.

### BRIEF DESCRIPTION OF THE SEVERAL VIEWS OF THE DRAWING(S)

FIG. 1 is a system schematic with functional components to perform tasks in accordance with some embodiments of the disclosure;

FIG. 2 is a view of a user interface in accordance with some embodiments of the disclosure;

FIG. 3 is a view of a user interface in accordance with some embodiments of the disclosure;

FIG. 4 is a view of a user interface in accordance with some embodiments of the disclosure;

FIG. 5 is a view of a user interface in accordance with some embodiments of the disclosure;

FIG. 6 is a block diagram illustrating an example of a computing environment that may serve as a hardware representation of several functional blocks in accordance with some embodiments of the disclosure;

FIG. 7 is a flow diagram illustrating a claim intake process in accordance with some embodiments of the disclosure;

FIG. 8 provides a sample hierarchy showing access rights in a load balancing, system in accordance with some embodiments of the disclosure;

FIGS. 9A, 9B, and 9C provide sample screenshots of a load balancing system in accordance with some embodiments of the disclosure,

FIG. 10 provides a sample screenshot of an Action Template program to manage catalogued actions;

FIG. 11 is a flow diagram illustrating a process overview in accordance with some embodiments of the disclosure; and

FIG. 12 is a flow diagram illustrating an assignment process in accordance with some embodiments of the disclosure.

### DETAILED DESCRIPTION

Embodiments of the disclosure provide a method to manage disability claims. The method involves obtaining claims data from an entity of interest, e.g., a healthcare provider, an insured employer or from an insured employee, through a claims intake process. The claims intake process may include obtaining additional data specific to the employee's absence. After the claim intake process, the method involves a claim determination process where the claim is approved, denied, and pended. In some embodiments, a distinction is made on which system handles more complex claims as opposed to less complex claims. For example, a long term health management system utilizing a Senior Abilities Coach may be set up to handle complex claims with longer duration management, and a shorter term health management system utilizing an Abilities Coach may be set up to deal with less complex claims. The method then involves providing a customized productive action plan for the employee based on the information gathered. Utilizing this customized productive action plan will enable an efficient return to work for the employee who filed the disability claim. Further, while the disclosure discusses disability claims, embodiments of the disclosure may be applied to medical insurance claims in a similar fashion as described for disability claims.

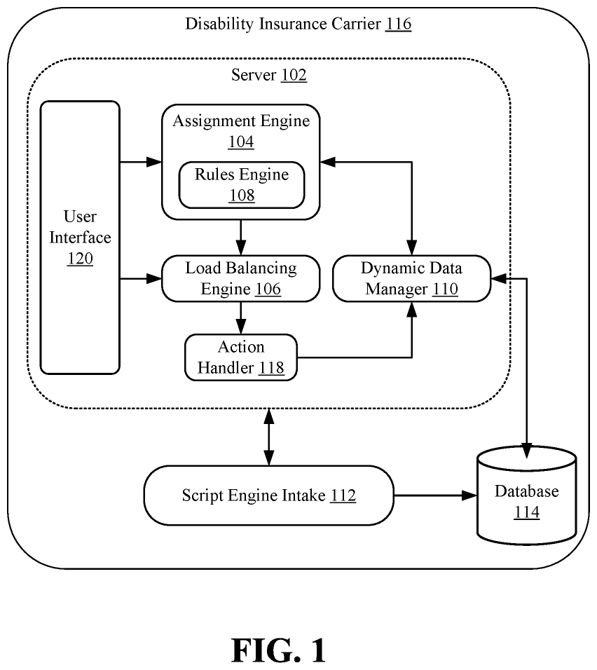

FIG. 1 provides a system schematic with functional components to perform tasks in accordance with some embodiments of the disclosure. In the illustrated embodiment, a Disability insurance Carrier 116 is shown. In other embodiments, the Disability insurance Carrier 116 may be replaced or combined with a Medical Insurance Carrier such that one or more of a disability claim or medical claim may be processed in accordance with the disclosure herein. In these embodiments, insurance claims, whether disability or medical, are reported to the system herein from a subscriber of a plan sponsor of the disability and/or medical insurance carrier. In these embodiments, the subscriber may be an employee of the plan sponsor. Alternatively, the insurance claim may be reported to the disability and/or medical insurance carrier from the plan sponsor itself, which would represent the plan sponsor as the subscriber reporting the claim.

Returning now to FIG. 1, the Disability Insurance Carrier 116 houses a Server 102, a Script Engine Intake 112, and Database 114, Script Engine Intake 112 gathers inputs from outside the Disability Insurance Carrier 116 and provides them to the Server 102 and Database 114. Typically, the inputs from the outside are insurance claims from customers, or in other words, subscribers or users of the Disability Insurance Carrier 116. In certain embodiments, Script Engine intake 112 gathers data related to a subscriber's insurance claim, such as diagnostic data, company data, insurance plan related data, state level regulations data, and any other data related to the subscriber's insurance claim. The data obtained by the Script Engine Intake 112 may be gathered in different methods. The Script Engine Intake 112 may gather data from a webpage or mobile application interface where a subscriber, e.g., employer/employee enters information. The Script Engine Intake 112 may also receive applicable data, e.g., claims data, from healthcare providers. The Script Engine Intake 112 may include an automated phone system to collect information from individuals. The Script Engine Intake 112 may also be set up to gather information through mail systems such as email and using technologies such as optical character recognition (OCR) on physical mail. In this manner, the Script Engine Intake 112 coupled with the method of gathering the data functions as an interface to the Server 102 of the Disability Insurance Carrier 116.

After gathering data from the different sources, the Script Engine Intake 112 relies on Database 114 to store the obtained data. The data may be organized as metadata in Database 114. In certain embodiments, the data may be organized as first elements of first metadata, where the first elements represent individual aspects of the disability insurance claim such a location of subscriber, age of subscriber, conditions related to the medical claim, etc. The first elements for the individual components of the first metadata that describes the claim data, Database 114 contains data for all claims and may be accessed to provide potential outcomes for the claims. Moreover, as the claim is processed and benefits are approved/provided, the data related to that claim will be updated in the Database 114 to reflect a current status of the claim.

Server 102 is coupled to the Script Engine intake 112 and Database 114. Server 102 is shown to include six components, an Assignment Engine 104, including a Rules Engine 108, a Load Balancing Engine 106 a Dynamic Data Manager (DDM) 110, an Action Handler 118 and a User Interface 120. Further, while the Server 102 is illustrated as a single server, Server 102 may be formed from a plurality of servers or be a cloud server.

From a high level, Assignment Engine 104 is responsible for rules creation and execution. A rule is a data container that holds a set of equations and a set of actions. When the Rules Engine 108 processes the equations defined for a rule, and if all, of the equations evaluate to True, then the actions for the rule will be processed. The Assignment Engine 104 is configurable by a supervisor through a script or through the User Interface 120. In this manner, an insurance claim supervisor is able to build one or more teams of members assigned to the supervisor who can process insurance claims assigned to them. In certain embodiments, the members are claim managers that are employees of the Disability Insurance Carrier 116 and supervised by a supervisory claim manager. In budding a team, the supervisor may add and remove team members, transfer team members, create paid time off (PTO) and unavailable time, set maximum case assignments, and create an organizational hierarchy. The Assignment Engine 104 is coupled closely with the Rules Engine 108 to process rules involved in making a claim assignment to a member.

In general, the Assignment Engine 104 is configured to process preset rules contained in the Rules Engine 108 for determining who to assign an insurance claim from a subscriber of the Disability insurance Carrier 116. The preset rules are configured via the User interface 120 to be performed in a certain order such that the insurance claim is properly assigned. In this manner, the Assignment Engine 104 ensures that the Rules Engine 108 performs the preset rules in an order to facilitate claims assignment.

An assignment by the Assignment Engine 104 is initiated whenever a new claim is reported to the Disability Insurance Carrier 116. Once a new claim is reported, the Script Engine Intake 112 notifies the Assignment Engine 104, which in turn requests metadata (composed as elements of metadata) stored in the Database 114 pertaining to that claim from the Dynamic Data Manager 110. The Dynamic Data Manager 110 retrieves the requested metadata and provides it to the Assignment Engine 104. The Assignment Engine 104 proceeds, via the Rules Engine 108, to process the preset rules in order to identify a particular member or members who should be considered for having the claim assigned to them. The metadata is able to be utilized to assign the claim because each member of the Disability Insurance Carrier 116 has capabilities and attributes describing the type of claims that member can be assigned, and the capabilities and attributes of each member are stored in the Database 114 and accessible by the Assignment Engine 104 for comparison against the metadata related to the claim data. In certain embodiments, the capabilities and attributes of each member is stored as assigned medical conditions represented by second metadata stored in the Database 114. Each assigned medical condition may represent a second element, of the second metadata. The second elements would be organized as being related to individual members such that the second metadata is a collection of second elements for each member of the Disability Insurance Cartier 116.

In this manner in certain embodiments, the preset rules function compare the first elements (medical conditions of the disability claim) of the first metadata of the claim to the second elements (capabilities and attributes of the members) of the second metadata. This comparison is done in order to narrow down a list of one or more members that are capable of handling the specific claim. As an example, a member ma be assigned, attributes such as being dedicated to a specific corporate subscriber of the Disability Insurance Carrier 116 such that the member supports claims only from employees of the corporate subscriber. Additionally, this member may be further assigned capabilities such as being a specialist for certain types of claims such as being an expert is pregnancy claims or claims related to addiction. In this manner, claims are automatically assigned to members most capable of moving the claim along quickly to ensure an efficient return to work of the employee to the corporate subscriber.

Additionally, in certain embodiments, a weighting analysis is performed when comparing the first elements of the first metadata to the second elements of the second metadata. The weighting analysis loofas for each member that has a collection of second elements that include a common match with each of the first elements of the first metadata. If such a match is found, those members are selected as potentially being assigned the disability claim related to the first metadata. However, if no available member has the particular collection of attributes or capabilities, then a second iteration of the comparison will be performed that removes certain individual first elements such that the comparison to the second elements becomes less rigorous. This process continues until at least one suitable member is found for handling the insurance claim.

The Assignment Engine 104 can be utilized to conduct assignments to members based on any number of attributes or capabilities of the members. In general, the member assignments are made to ensure that a member's expertise is being utilized properly such that the subscriber who provided the insurance claim experiences a more streamlined return to work process. In this regard, assignments are made to the members most capable to process a specific type of insurance claims. For instance, utilizing the Assignment Engine 104, team members can be assigned to less complex claims management and/or complex claims management. The team members designated to the less complex management will typically work with the Abilities Coach that can make determinations regarding the insured claimant's ability to return to work, and the team members designated to the complex management will work typically with the Senior Abilities Coach who functions similarly to the Abilities Coach but for more complex claims. By having the team member work with either the Abilities Coach or Senior Abilities Coach, and having this assignment being an automated process, the team member will be able to efficiently process and assist the disabled employee customers of the Disability Insurance Carrier 110 in returning to work for their employer sooner.

In some embodiments, the Assignment Engine 104 may be utilized to configure a team customer list where some team members work on dedicated customer accounts such as a specific company that provides insurance coverage for its employees with the Disability Insurance Carrier 110, some on special handling accounts, and some on designated accounts. The teams working on dedicated customer accounts only handle the identified account due to the sensitivity attributed to the customer. The teams working on special handling accounts deal with complex accounts that require special rules or accommodations in order to evenly spread claim assignments among a small group of team members. The teams working on designated accounts deal with small accounts with no exception handling in which the claim volume is spread across multiple teams.

In some embodiments, the Assignment Engine 104 may be utilized to configure team member optional attributes. For example, a team Member may be designated to handle pregnancy only claims and the team member is given a larger claim inventory to handle due to the ease of administration. A team member may be classified as statutory only which means that rules are in claims with a state cash plan that requires special handling are assigned to a specific group of benefit managers. A team member may be classified by claim plan which means that rules are in place to administer some claims by select members based, on the claim plan, for example, union plans vs. non-union plans. A team member may be designated based on a work state, meaning rules are in place to administer some claims by the state, for example, in certain states, claims must be managed by certain vender offices designed to process insurance claims in that state. A team member may be designated to work related injury, that is, the team member is identified to handle work related claims for coordination with Workers' Compensation vendors and provide specific handling for these types of claims. A team member's load may be determined based on claim tier, that is, claims with higher complexity are spread among the team along with claims that are less complex to provide a more balanced distribution of work. A team member may be specialized based on leave reason, for example, a team member may handle only military claims or bonding claims. Teams may be assigned certain claims based on a behavioral health category, so automatic referrals to behavioral health resources are made for claims with a mental or nervous component based on the triggers collected during the claim intake process.

In some embodiments, the Assignment Engine 104 may be further utilized to configure a benefit authority for a team member. The benefit authority may set limits for claims, total benefits, and, expense payments. In this regard, as claim data is updated in the Database 114 it is provided back to the Assignment Engine 104 for being communicated to a previously assigned team member for that claim. In certain instances, the updated claim data pertains to benefit payments approved for that claim. Typically, a claim has a set benefit amount that can be approved by the assigned team member before that member must get permission from a supervisor. This set amount is generally set up based on the type of claim. For example, a supervisor may set for each claim type a maximum amount that a team member can approve per day. Benefit payments that exceed the limit are automatically held until a supervisor review is performed. Supervisors are notified and the approvals are queued for timely review and management. In some embodiments, there is an automated escalation path if a supervisor does not take action on the benefit approval through the organizational hierarchy, and benefits that exceed a supervisor's authority are automatically referred to a next level for review. In another example, for each claim type, a maximum amount that a team member can approve for the life of the claim may be set using, the Assignment Engine 104. Once the claim limit is reached, any new benefit payments are automatically held until a supervisor review is performed. In another example, a maximum amount that a team member can issue as an expense payment without requiring a further review may be set using the Assignment Engine 104.

In some embodiments, supervisor delegation may be configured utilizing the Assignment Engine 104. For example, one configuration may be that all benefit authority notifications will be routed to a peer or superior of a certain supervisor. This is done when the supervisor will be going on leave or working on a special project for an extended period of time. The benefit authority notifications may be set to be routed for a specified period of time and may alternatively set the delegation to be permanent.

In some embodiments, team member permissions may be configured utilizing the Assignment Engine 104. Permissions may include permission to bypass denials, bypass suspensions, and bypass terminations. In bypassing denials, a team member may be given permission to approve denials that meet specific conditions without requiring a second review. In some embodiments, these may be used for low risk denials due to a return to work or death of the member while other denials will be referred for second level review. In bypassing suspensions, a team member may be given permission to approve a claim suspension if it meets specific conditions without requiring second level review. In bypassing terminations, a team member may be given permission to approve a claim termination of benefits if it meets specific conditions without requiring second level review.

The previous description of the various configuration capabilities using the Assignment Engine 104 may be categorized in three categories. These three categories of abilities provided by the Assignment Engine 104 are team administration, benefit authority, and team member permissions.

Under team administration, the Assignment Engine 104 allows supervisors to build teams, add subscribers (e.g., insured employers or employees) to be assigned to the team, add team members, and add the work they should be assigned. Utilizing the Assignment Engine 104, the supervisor will be able to set maximum case assignments for various team members over periods of time that the system will make and can also remove team members from all assignments due to vacation or leave.

Under benefit authority, the Assignment Engine 104 allows supervisors to set the maximum payment authority a team member can approve and set other team member resources, such as a supervisor that will review and approve overpayments up to their limit. Based on the parameters set, the Assignment Engine 104 automatically escalates the benefit approval to the next team member resource in line that has the authority to approve the benefit.

Under team member permissions, the Assignment Engine 104 allows supervisors to add or remove permissions to bypass approvals on claim denials that meet established criteria, and in addition, provide situations where claim suspensions and termination of benefits can be approved without further review based on permissions.

In certain embodiments, each of the above described functions of the Assignment Engine 104 are configured via the User Interface 120. In this regard, the User Interface 120 is utilized by a supervisor to configure the Assignment Engine 104 such that it is able to handle team administration, set benefit authority, and define team member permissions, as discussed above.

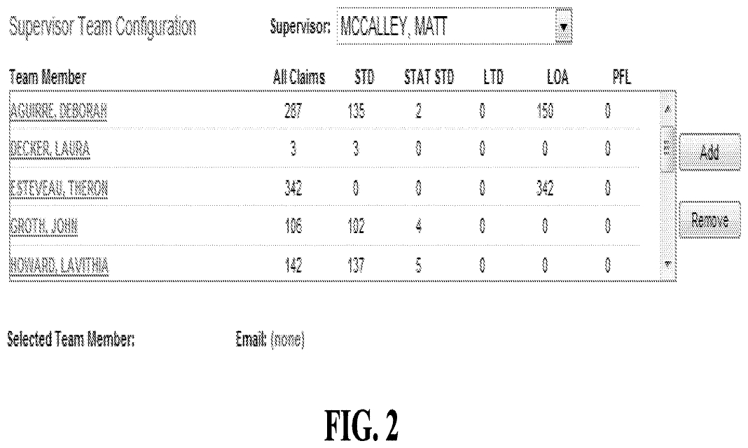

For instance, FIG. 2 illustrates a supervisor team configuration interface or view of the User Interface 120. In the illustrated embodiment, a supervisor “MCCAULEY, MATT” is selected and the various team members assigned under the supervisor are listed below. Further, a table of the various claims that are assigned to each team member under the supervisor is provided. From this view of the User Interface 120, the supervisor can add or remove team members using the “Add” and “Remove” buttons.

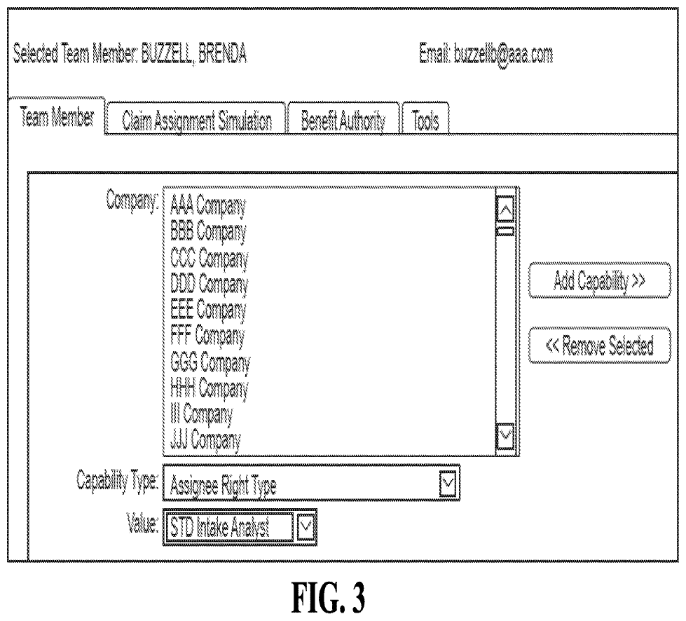

Further, the supervisor can select an individual team member that will take the supervisor to a “Team Member” interface or view of the User Interface 120, as shown in FIG. 3. In this view, the supervisor is able to set Mat particular team member's capabilities or attributes. In the illustrated example, a team member named “BUZZELL, BRENDA” is shown and the list of companies (subscribers to Disability Insurance Carrier 116) assigned to the team member is provided in the box labeled “Company”. Initially, when the team member is assigned to the supervisor, as shown in FIG. 2, each subscriber company assigned to the supervisor is also assigned to the team member. This can be altered by the supervisor though by using the “Remove Selected” box, which enables the supervisor to select a subscriber company and remove it from the list of subscriber companies that team member is assigned to support. In this manner, the team member is assigned to process claims from certain subscriber companies.

Additionally, the supervisor can set attributes and capabilities of the team member using the “Capability Type” and “Value” drop-down boxes The “Capability Type” drop-down box allows a supervisor to specify a capability, as discussed above, for a particular team member, and the “Value” drop-down box allows the supervisor to set a value for the capability for the team member. For instance, a team member can be assigned to handle long term disability (LTD) or short term disability (STD) claims for the listed subscriber companies. In this example, as also shown in the illustrated embodiment, the supervisor has selected “Assignee Right Type” in the “Capability Type” drop-down box. An assignee right type is basically a job description, such as an intake analyst or a claim (e.g., STD, LTD, Leave of Absence (LOA) or Paid Family Leave (PFL)) owner, or a nurse case manager. Also, in the illustrated embodiment, the supervisor has provided, via the “Value” drop-down box, that this team member will function as a “STD Intake Analyst” for the “Assignee Right Type” for above listed subscriber companies. This capability is then added to that team member by selecting the “Add Capability” button. In this manner, any type of attribute or capability can be set for each team member assigned to the supervisor. Moreover, in certain embodiments, these attributes and capabilities are stored in the Database 114 as assigned medical conditions representative of medical conditions the individual members may be assigned to treat. Further, these assigned medical conditions may be stored as elements of metadata in the Database 114. In this manner, the stored elements of metadata can be accessed by the Assignment Engine 104 (see FIG. 1) for use in assigning a member to handle a disability claim.

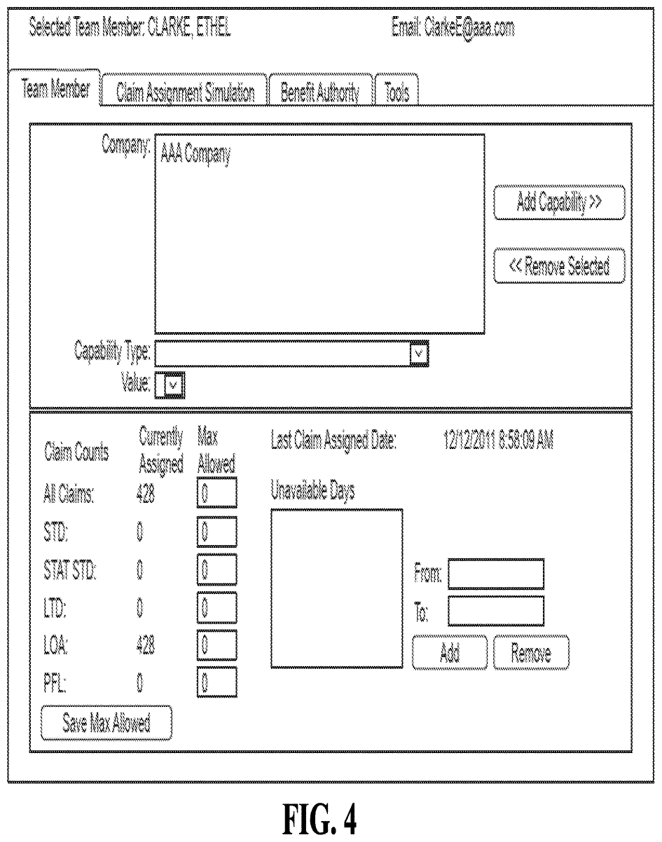

A further embodiment of the “Team Member” view is illustrated in FIG. 4. In this embodiment, a claim assignment data interface is provided for that team member. In the illustrated embodiment, it is shown that this team member currently has 428 claims assigned that are LOA claims. From this screen of the User interface 120 (see FIG. 1), the supervisor can also set a maximum number of claims, based on claim type, that can be assigned to a team member. To accomplish this assignment of a maximum number of claims that can be assigned to a specific team member, the supervisor only needs to enter the maximum number in the box next to the various types of claims under the “Max Allowed” heading and then select the “Save Max Allowed” button. This will then limit the number of certain types of claims that may be assigned to this team member through the Assignment Engine 104 (see FIG. 1).

Further, a date that a claim was last assigned is provided in the claim assignment data interface of FIG. 4. As illustrated, the claim assignment data interface includes a “Last Claim Assigned Date” that provides a time of last assignment, which is a date on which the selected claim manager was last assigned a disability claim.

Additionally, FIG. 4 illustrates a box showing days that the team member is unavailable to be assigned claims. As such, from this screen, the supervisor is able to administer days off of work for the various team members. Any such days that a team member is unavailable are shown in the “Unavailable Days” box, and the supervisor can add those days by entering a starting date in the “From” box and an end, date in the “To” box. After entering the dates, the supervisor may select the “Add” button, and the User interface 120 (see FIG. 1) will automatically populate those dates into the “Unavailable Days” box. Additionally, any dates entered into the “Unavailable Days” box may be removed by selecting those dates from that box and then selecting the “Remove” button.

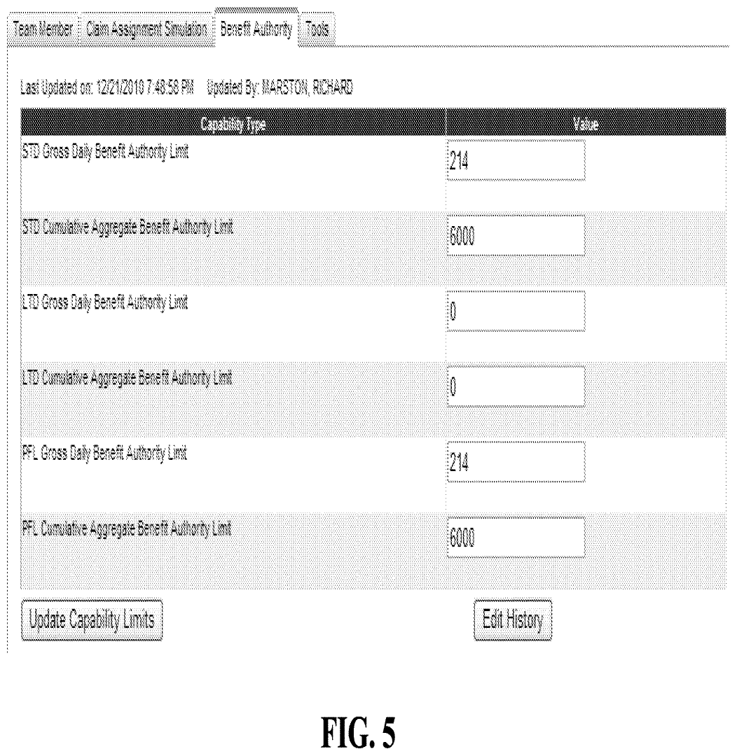

FIG. 5 illustrates a Benefits Authority interface or screen of the User Interface 120 (see FIG. 1). The Benefits Authority screen allows a supervisor to set a limit to benefits that a team member can approve for various types of claims. In the illustrated embodiment, a team member “MARSTON, RICHARD” is able to approve $214.00 worth of benefits for a STD or PFL claim on a daily basis and $6000.00 Worth of benefits cumulative for the STD or PFL claim over the course of the management of that claim. The supervisor is also able to update these limits by entering a new value in the data entry box and selecting the “Update Capability Limits” button.

Returning now to FIG. 1, a Load Balancing Engine 106 is illustrated as part of the server 102. The Load Balancing Engine 106 obtains team member information from the Assignment Engine 104 during claims assignment and balances the load of claims between each of the team members. In this manner, the Load Balancing Engine 106 reviews certain aspects of the loading of each member available to be assigned responsibility of a disability claim in order to balance an assignment load between the various team members. In certain embodiments, the Balancing Engine 106 utilizes the above discussed time of last assignment to balance the load of claims between team members. In these embodiments, a new disability claim assignment is based on which team member in a list of team members determined (by the Assignment Engine 104) to be capable of processing the new disability claim was assigned a disability claim farthest back in time. In this manner, the list of team members determined to be capable of processing the new disability claim form a line where the team member assigned an insurance claim the longest period of time ago is at the front of the line fro the next assignment. The various team members cycle through this line as new disability claims are presented to the Disability Insurance Carder 116.

In certain embodiments, the number and type of claims assigned to each team member by the Assignment Engine 104, determines who may be assigned the claim, and allows the Load Balancing Engine 106 to make a decision on which team member to assign the claim such that the number of claims being processed by the team members is distributed among the team members in a balanced manner. In order to accomplish this, the Load Balancing Engine 106 receives parameters from the Assignment Engine 104 designating whether the subscriber assignment should follow a dedicated model or a designated model. In the dedicated model, the subscriber has team members specifically assigned. In the designated model, the subscriber does not have a dedicated team, and assignments are based on other criteria. Load Balancing Engine 106 may include rules that are subscriber based (or individual based) in terms of precedence for certain claims. For instance, a pregnancy with complications is directed to specific teams or team members as opposed to a pregnancy without complications. Additionally, the rules narrow down team members based on who can handle that claim and when they were last assigned a claim. Load Balancing Engine 106 may accept new rules based on, customer needs, new laws, etc. A new rule may be based on improving and changing how certain claims are handled.

In certain embodiments, once the Load Balancing Engine 106 selects the team member to assign the claim to the Load Balancing Engine 106 passes that information to the Action Handler 118. The Action Handler 118 then proceeds to assign that claim to the selected team member, who then becomes the claim manager for that claim. The Action Handler 118 assigns the claim by sending the selected team member to the Dynamic Data Manager 110 such that the team member can be stored in the Database 114 as the claim manager for that claim. In this manner, a team member is assigned as handling a claim.

In general, all rules and action processing may be abstracted through the Action Handler 118. The Action Handier 118 is a tool used to develop actual software code to perform actions that may be shred as rules. These actions may then be utilized by any system, such as the Assignment Engine 104, to perform the software defined action.

The Action Handler 118 has a certain number of actions that may be chosen or used, but an example will be used to illustrate the role Action Handler 118 serves. In some embodiments, a supervisor requests the ability to load balance claims assignments for a team of claim managers. In the design phase, the Action Handler 118 creates code with annotations that identify the ability of load balancing, while optionally making the code searchable. For example, a decorator or tag <AvailableAction(“ ”)> may be used. After creating the code required, the code is compiled into a dynamic link library (DLL). The Action Handler 118 then catalogs the method and allows, tools to point to this DLL. For example, an Action Template tool may be utilized to manage all functionality in order to locate and search DLL's for uncatalogued actions, associate the action to a system trigger, associate registered fields to a parameter on the action, auto generate all code required to interface the Rules Engine 108 and metadata and commands to physical code and data at runtime. In this manner a new action that may be performed utilizing the Assignment Engine 104 may be created.

The Dynamic Data Manager (DDM) 110 is a software interface between the Rules Engine 108 and Database 114 and more generally the interface between the Server 102 and the Database 114. The DDM 110 receives keys from the Rules Engine 108 and retrieves data relevant to the key from the Database 114. For example, when retrieving data from Database 114, if a multiple sclerosis (MS) claim is received, then the system can use the DDM 110 to find in Database 114 relevant data related to the MS claim in order to determine relevant events. Relevant events may include improving or declining health, estimated days before an injured worker may return to work, involvement of a mental health specialist to help with diagnosis, etc. In some instances, when a new rule is to be implemented, changing how certain claims are handled, if metadata already exists, then the DDM 110 can access that data for the new rule. If metadata currently exists and new metadata is needed, then that data structure will need to be created and made accessible by the DDM 110. In this manner, new claim types can be added and stored in the Database 114 such that the DDM 110 is able to retrieve the requested metadata for that claim.

The Rules Engine 108 then acquires this data and uses it to process rules for the Assignment Engine 104. In the example provided above regarding the MS claim, the relevant events collected about the MS claim are processed by the Rules Engine 108 such that a model action plan associated with the MS claim is provided to the assigned team member. Using the model action plan, the team member will be able to provide a dedicated service oriented to return the disabled employee customer who filed the MS claim to work in an efficient manner. This model action plan can be updated and altered as additional data on how the disability is progressing is appended to the claim data in the Database 114. As additional data is appended, the DDM 110 will pull that data and provide it to the Rules Engine 108 to modify a team member assignment if necessary such that a team member with an appropriate level of authority is assigned to the claim for executing the action plan.

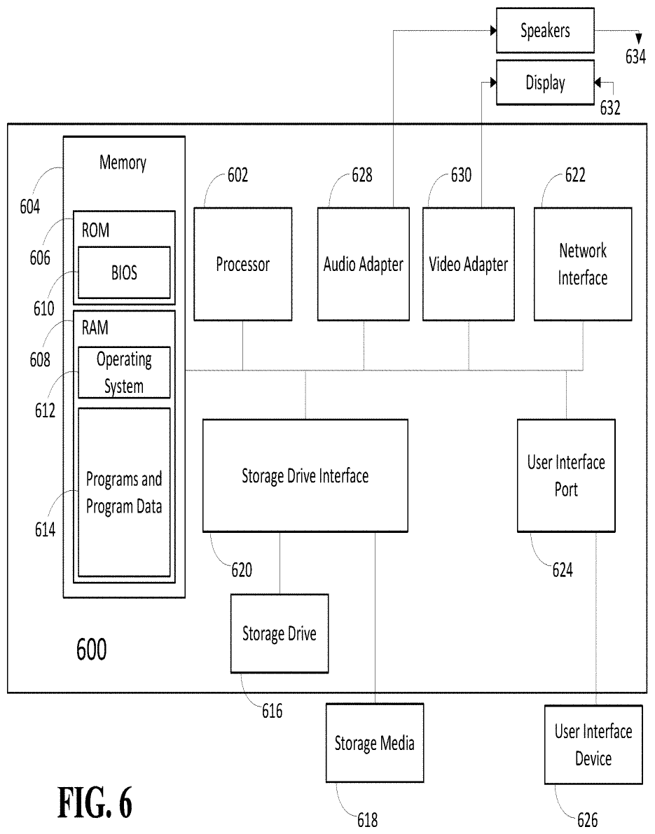

FIG. 6 is a block diagram illustrating an example of a computing environment that may serve as a hardware representation of the Server 102, the Database 114, or Script Intake Engine 112. Those of ordinary skill in the art will understand that the meaning of the term “computer” or “computing” as used in the example is not limited to a personal computer but may also include other microprocessor or micro-controller based systems. For example, embodiments of the disclosure may be implemented on mainframes servers, internet appliances, microprocessor based or programmable consumer electronics, multi-processor systems, tablet computers, or networked combinations of the previously mentioned devices.

The computing environment may include a computer 600, which includes a pro essay 602, memory 604, and a system bus to facilitate communication between different units of computer 600. The memory 604 may include a read only memory (ROM) 606 and a random access memory (RAM) 608. In some embodiments, the ROM 606 stores basic input/output system (BIOS) 610 which contains basic routines that assist in information exchange between different units within the computer 600. The RAM 608 is working memory and may store a variety of items including parts of the operating system 612, and programs and data necessary for correct operation of these programs 614. The computer 600 may include a storage device 616 with a higher capacity than RAM 608 Storage device 616 may be multiple hard disk drives (HDDs), solid state drives (SSDs), magnetic disk drives, hybrid drives, optical disk drive, etc. Computer 600 may interface removable drives or storage media 618 which may include flash drives, optical media, etc. Storage Drive Interface 620 interfaces internal and external storage options with the system bus.

In some embodiments, a user (e.g. a supervisor or team member) may enter commands and information into computer 600 through user interface device 626. User interface device 626 includes a microphone, a touch screen, a touchpad, a keyboard, a mouse, a joystick, and a stylus. User interface Port 624 interfaces the User Interface Device 626 with the system bus. The port 624 may include a serial port, a parallel port, a universal serial bus (USB), a game port, a proprietary port, a 1394 port, a microphone port, etc. Computer 600 may further include one or more network interfaces 622 to provide network connectivity with one or more devices Network interface 622 may be a wired or wireless network interface, supporting several wireless technologies including Bluetooth®, Wi-Fi, ultra-wide band (UWB), wireless USB, ZigBee, WiMAX, long term evolution (LTE), etc. Lastly, computer 600 may interface with input and output devices. In FIG. 6, audio adapter 628 and video adapter 630 provide connections to a speaker 634 and display 632, respectively.

Various exemplary functions and processes performed within the Disability Insurance Carrier 116 are discussed below. First, an exemplary claim intake and return to work process is described. Second, an example illustrating a claim type assignment after the claim intake process is completed is provided. Third, an exemplary load balancing implementation that ensures the various claims are distributed among team members appropriately is provided. Finally, an exemplary operation of the Action Handler 118 is provided.

Moreover, the below discussion, in certain places, references are made to claim managers. As used herein, a claim manager is a team member that has been assigned a claim for management. As such, the below discussion will reference capabilities of a claim manager to handle certain types of claims in a similar fashion to the above discussion regarding team members. As team, members and claim managers are really one in the same, the name change is made to illustrate how the above discussion at least partially pertains to a supervisor setting up a team as compared to the discussion below directed to the previously mentioned exemplary functions and processes.

### Exemplary Claim Intake and Return to Work Process

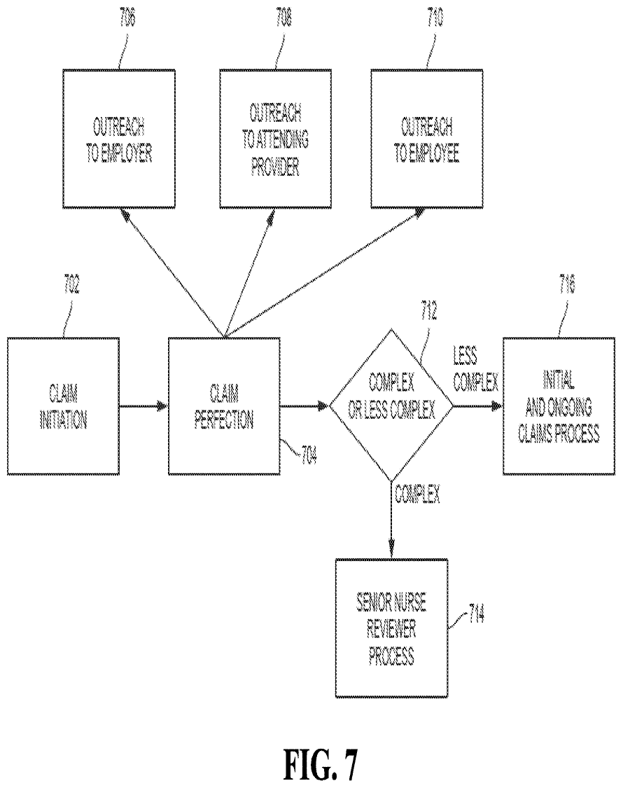

The following discussion will provide claim management scenarios using the system provided in FIG. 1 and also the flow diagram provided in FIG. 7. The claims process begins when an employee reports medical leave, personal injury/illness, or requests, from an employer, a company leave. The employer may then direct the employee to report the absence by contacting Disability Insurance Carrier 116. After contacting the Disability Insurance Carrier 116, a claims intake process is initiated at step 702. The claims intake process may be started by an employee or employer though a web form, a telephonic conversation, an instant messaging application, a mobile application, fax, or mail. The claims intake process may involve verifying coverage of employee by the Disability Insurance Carrier 116 and documenting medical history, present symptoms, treatment, and follow-up appointment information obtained from employee, employer, and healthcare providers.

Once a claim intake has been initiated, a claims perfection step may be performed at step 704. In claims perfection, short term disability (STD) claim eligibility is verified and outreach to the various parties of interest is performed at steps 706, 708 and 710. For example, the employer and the employee may both receive communication from the Disability Insurance Carrier 116 within a certain timeframe. For example, Disability Insurance Carrier 116 may send an email to the employee, healthcare provider, and the employer within 2 business days of claim creation. The communication mode may be bidirectional, allowing the Disability Insurance Carrier 116 to receive verification and extra information regarding the claims data of interest. In some instances, the claims being perfected contain a procedure or Current Procedural Terminology (CPT) code or a diagnostic or International Classification of Diseases (ICD) code. The CPT code or ICD code may be used to determine whether a claim is complex or less complex, at step 712. When either code is determined to be complex, then the claim undergoes a Senior Nurse Reviewer (SNR) process with an SNR or a Senior Abilities Coach, at step 714. When either code is determined to be less complex, then, at step 716, the claim is processed in the ordinary course by assigning a team member to process the claim. Examples of less complex claims include simple surgery or pregnancy codes while complex claims include diabetes, cardiac disease, or psychological codes.

In some embodiments, less complex claims can be reviewed under the SNR process at any time if the claim owner, i.e., a team member currently assigned to manage the claim, determines the claim would benefit from a clinical review. The SNR process may include any one or more of the following: (1) Referral to the BHU; (2) Strategic claim discussions (SCD) which include clinical, vocational, and claim management resources; (3) Medical claim management which include medical director, independent medical examination (IME), functional capacity evaluation (FCE), field care management (FCM), and peer review; (4) fraud investigation which includes a risk management unit (RMU), (5) vocational management which includes vocational resources, for example, vocational rehabilitation consultants (VRCs); and/or (6) Medical case management which includes integrated health and disability (IHD).

When a claim or a new case is received, initial responsibilities of an SNR include checking for concurrent STD/Family Medical Leave (FML) claims and past medical history. Once IHD consent is verified, the reviewer checks medical systems for clinical information, initiates referral, and begins a collaboration process with medical programs. If IHD consent is not on file, the SNR will give direction to a Disability Benefits Manager (DBM) to request consent at a next contact and to integrate as appropriate. The SNR further reviews STD claims for diagnostic data, medical data, appropriateness of treatment and duration guidelines by diagnostic codes to assess employee functional capacity. The SNR will complete provider outreaches to resolve complex clinical issues as warranted. And the SNR may assign the claim within a couple of days from claim creation to a DBM who functions as the above discussed team member who has been assigned the claim to process as a claim manager. The SNR then educates the claim manager on expected clinical progression and disease process and identifies and facilitates modified return to work (RTW) potential. Then the SNR determines if ancillary clinical resources are required as the claim is updated within the Database 114 (see FIG. 1) over the progress of the claim.

In some embodiments, once a history is created, the SNR reviews all STD claims on an ongoing basis at intervals based on clinical criteria, diagnosis, duration, guidelines, co-morbid factors and clinical acuity. The SNR then assists the claim manager with clinical questions, for example, by providing guidance on claim direction from a clinical perspective and assessing referral to disability clinical resources based on clinical guidelines, durations and judgment. The SNR will complete healthcare provider outreaches to resolve complex clinical issues as warranted. The SNR will ensure an appropriate level of claim/medical management. The SNR then assists in modified RTW discussions and makes recommendations for referral to vocational rehab as clinically appropriate. Ongoing review of all clinical Systems throughout the STD claim may be performed as well. The SNR may then make referrals and collaborate with medical management programs/staff as deemed appropriate.

The system performs an ongoing claims management which includes obtaining ongoing medical information as appropriate and reviewing for the medical information or RTW potential. A Medical Disability Advisor (MDA) and other clinical tools are utilized for determination of benefit duration and determination of RTW potential. During claims management, employees are contacted regarding claim status and administrative issues as needed, and benefit payments and advises to pay are issued as well. In this process, further processing may be utilized by referral to SNR and other clinical consultant resources. The process further involves notifying the employer of any change to an employee's RTW status.

After a claim intake is performed but before the RTW determination is made, the claim may be assigned to a claim manager to supervise the progress of the claim in order to ensure an efficient process leading, to the RTW determination. As discussed below, a claim manager is synonymous with a claim owner or a team member assigned a certain claim. Below is a discussion regarding claim type assignments once the claim has already gone through the above described intake process.

### Example Illustrating Claim Type Assignments

After claim intake, the Assignment Engine 104 (see FIG. 1) is utilized to assign, the claim to a team member to function as the claim manager for that claim. An example illustrating the assignment processor for short term disability (STD) and long term disability (LTD) claims will be provided in accordance with some embodiments of the disclosure. When a claim is received, the claim is deemed either complex or less complex during the intake process. When a less complex claim is received, the less complex claim is assigned based on a rotation of the next STD claim manager in line for assignment, as performed by the Load Balancing Engine 106 (see FIG. 1). Typically, the Assignment Engine 104 will direct these claims to junior claim managers since little or no clinical oversight is required during the period within duration guidelines.

The Assignment Engine 104 (see FIG. 1) searches for team members to be claim managers by plan, state, and claim tier (i.e., less complex or more complex). Claim manager assignment within the Assignment Engine 104 may be configured to be assigned claims based on several characteristics associated with the claim. For example, when the state that a claim originates in is New Jersey, a claim manager assigned to handle claims from New Jersey will be assigned the claim. Claim managers may be assigned based on various reasons, for example, all pregnancy claims or all claims due to back conditions are handled by specific claim managers that may have experience dealing with these types of claims. In other examples, the type of medical plan determines claim manager assignment, so a rule may be set up where all union plan employees are handled by a specific team of claim managers. The claim tier may also determine claim manager assignment, for example, all high risk medical condition claims may be handled by a Nurse Case Manager in conjunction with claim manager or just a Nurse Case Manager alone. Claim manager assignment may be further determined by CPT code or ICD code and medical condition where specific detailed codes can be carved out and assigned to certain claim managers with expertise in those types of claims.

Sometimes a claim may have exceeded a designated time to stay in STD and may be transitioned to a LTD claim. This transition would be updated in the Database 114 (see FIG. 1) such that the Assignment Engine 104 recognizes the change and can facilitate reassignment of the claim, if need be. In certain embodiments, assignment may be kept with the claim manager of the STD claim instead of assigning the claim to a new claim manager that handles LTD claims. However, in other embodiments, a new claim manager that handles LTD claims may be assigned by the Assignment Engine 104.

In some embodiments, an additional claim assignment is automatically made to a team nurse or referred to an SNR in addition to a previously assigned claim manager once certain physical triggers are identified during the normal course of processing the claim. These triggers can be based on the insured employee's or insured patient's self-reported medical condition or through the addition of ICD or CPT codes to the claim. Once these triggers are added to the Database 114, the Assignment Engine 104 (see FIG. 1) will he notified so to make the additional assignment. The team nurse will work with the claim manager for proper medical management of the claim and also work with the claim manager to identify and facilitate a quick, and safe return to work.

In some embodiments, the system performs ongoing management or diagnostics to determine if a currently assigned claim manager has the capabilities to continue to own the claim. This ongoing management may he performed each time medical information is updated on a claim in the Database 114 (see FIG. 1). The system then determines whether the claim should be reassigned to a new team member to function as the claim manager. For example, if a nurse case manager is currently assigned to the claim and the medical triggers no longer warrant this level of oversight, the reassignment will occur. The ongoing management involves the Assignment Engine 104 (see FIG. 1) performing a check for a resource based, on the claim reason, work state, work related injury claim plan, claim tier, and ICD code, as stored in the Database 114.

In some embodiments, the system determines when to transition a STD claim to a LTD claim once a claim duration threshold has been exceeded. As duration guidelines associated with the ICD and CPT codes matched to the claim expire, the Assignment Engine 104 (see FIG. 1) performs a check to determine if the claim should he reassigned to a new claim manager dedicated to handle LTD claims. For example, a simple maternity claim that exceeds duration guidelines may be assigned to a clinical nurse case manager for increased medical oversight.

As discussed above, the Assignment Engine 104 (see FIG. 1) will assign claims to certain claim managers based on metadata associated with the claim. Disability Insurance Carrier 116 will include a plurality of case managers and other employees dedicated to servicing claims from insurance customers. The Assignment Engine 104 will utilize the Load Balancing Engine 106 in order to make sure the claim assignments are evenly dispersed among the available claim managers employed by the Disability Insurance Carrier 116. The following is an exemplary discussion of the operation of the Load Balancing Engine 106.

### Exemplary Load Balancing Implementation

In some embodiments, the Load Balancing Engine 106 may use a series of setup screens and runtime components that allow claims to be automatically assigned to a claim manager based on claim content, claim manager capabilities, and processing rules. As previously discussed, load, balancing may be performed using two models, a dedicated model where claim managers are dedicated to a particular company subscriber with specific skills or a designated model where claim managers not in the dedicated model are assigned claims to any company subscriber not declared as dedicated. The claims assignment process when considering load balancing is based on three major concepts—claim manager capabilities, assignment processing rules, and claim information.

The first concept, claim manager capability, may be quantified through attributes that allow a claim manager to state “I can do this type of work.” These attributes are set up in the system and stored in Database 114 beforehand, and they are provided as inputs when determining load balancing functions performed by the Load Balancing Engine 106. Examples of claim manager capability include: (a) For company 123, I can receive only claims with a specific ICD code, such as ICD9 code 650, (b) For company 123, I can receive claims for FML claims, and (c) For company 123, I can receive any claim. In some cases, claim manager capability can be very specific as provided in example (a) above where. the specific ICD code 650 is identified. Claim manager capability may also be very general as in example (c) where the claim manager can receive any claim. In some embodiments, the general nature provided in example (c) is retained and used for an overflow situation such that claims may be assigned to these claim managers in order to alleviate an overloading for claim managers that have a more limited range of claim assignment capabilities. As illustrated in the above example, claim manager capabilities are defined for a dedicated company. However, the Load Balancing Engine 106 may be configured to define claim manager capabilities not based upon a certain company that an insured employee works for, but just make claim assignments in general to claim managers that are not specifically assigned to one or even a set of companies. Claim manager capabilities may identify a claim manager with respect to a specialty, for example, a specialized procedure, a specialized condition or diagnosis, a specific company, a specific product, etc.

The second concept mentioned above regarding load balancing, as performed by the Load Balancing Engine 106 (see FIG. 1), considers assignment processing rules, which typically entail two types of assignment rules dedicated assignment rules and designated assignment rules. The dedicated assignment riles involve a claim assignment process based on a set of rules that attempt to derive a claim manager, to assign the claim to, based on capability and claim content. These rules are controlled by the Disability Insurance Carrier 116 and can bet set up to drive specific claim types to the appropriate claim in an ager. The Load Balancing Engine 108 will process the rules in order and assign the claim to the first claim manager found based on capability, availability, and case load. The designated assignment rule moles a claim assignment process where the claim is assigned to a claim manager with claim owner rights for the company defined on the claim based on case load and availability.

The third concept mentioned above regarding load balancing, as performed by the Load Balancing Engine 106, may assign claims to claim managers based on claim information. This would instruct the claim assignment process through claim information that the Disability Insurance Carrier 116 has previously identified as being pertinent to handling claim assignments. For example, the Disability Insurance Carrier 116 may identify certain products, divisions, claim offices, leave continuity, etc., and use that information to direct the Load Balancing Engine 106 to balance the claim load among certain claim managers.

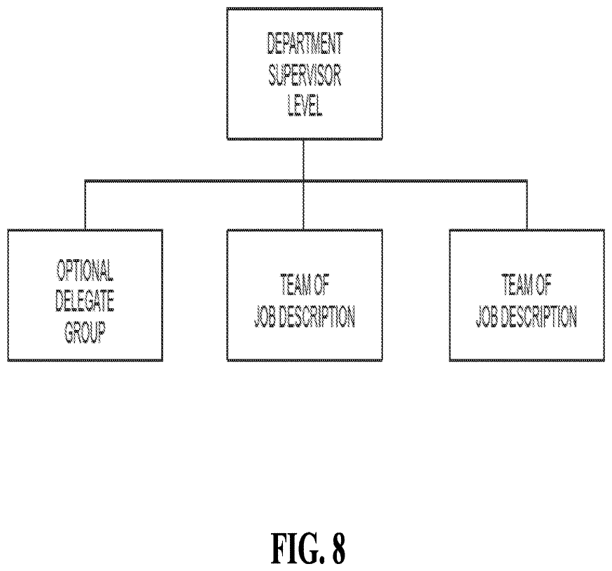

In some embodiments, the Load Balancing Engine 106, when performing load balancing, may speedy a load balancing team to handle certain claims. A load balancing team is a set of team members, or in other words, claim managers that can be set up by a supervisor or optionally a delegate defined by the supervisor. Team members are selected from claims managers that exist within the supervisor's team hierarchy that base at least one claim ownership right. FIG. 8 provides a sample hierarchy showing access rights from supervisor level, optional delegate group, and team members. There are certain constraints inherent in the setup of FIG. 8. Firstly, members for a load balancing team are selected from employees defined in the subgroups below the Department Supervisor level. Secondly, the optional Delegate group must be a direct child of the supervisor group and have the right to manage load balancing. As such, the delegate group is provided visibility to all peer groups and their children. Thirdly, members of a load balancing team are selected from claim managers defined in the subgroups below the Department Supervisor level. Fourthly, in certain embodiments, the hierarchy is designed to need more designated vs. dedicated claim managers.

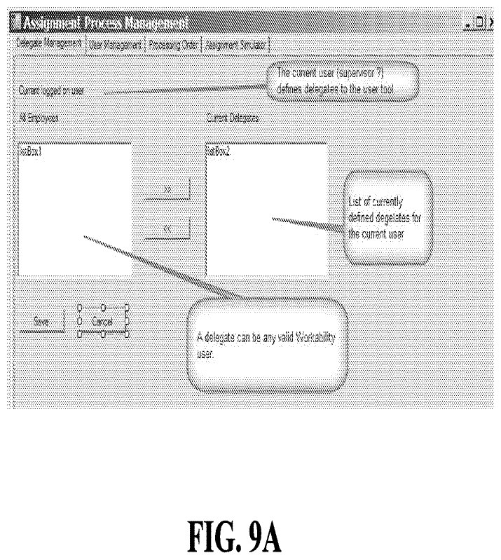

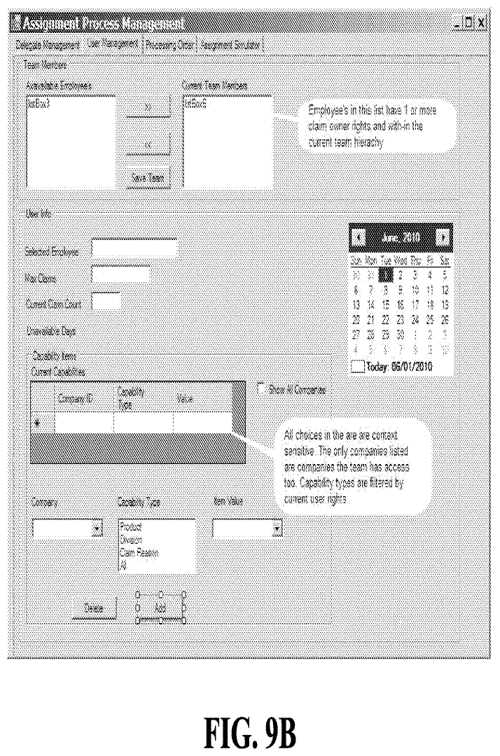

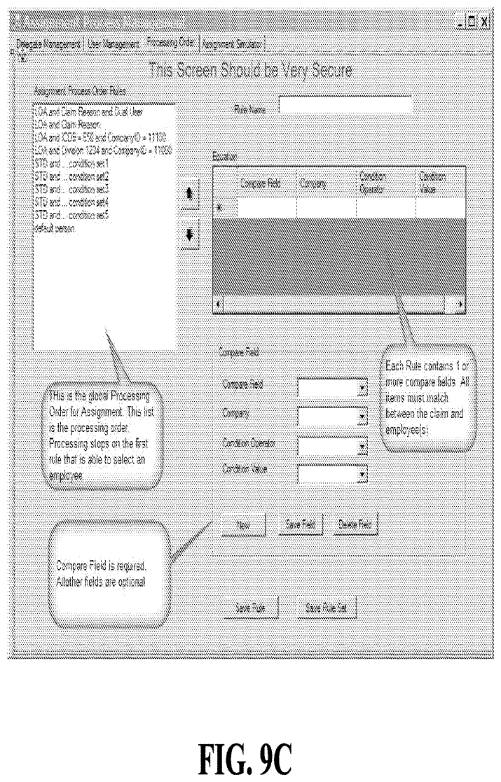

FIGS. 9A, 9B, and 9C provide example screenshots for a load balance team setup aspect of the User Interface 120 in accordance with some embodiments of the disclosure. In FIG. 9A, all claims managers are listed under “All Employees” box. Employees selected as delegates will be listed under “Current Delegates” box. In some embodiments, as employees are added as delegates, they are removed under the “All Employees” box.

In FIG. 9B, the screenshot shows assignment considerations. The “Available Employees” box shows employees that have at least, one claim ownership right, and “Current Team Members” box shows employees currently selected to a team. The section identified as “User Info” defines information of a single user, such as a claim manager. The information listed in the “User Info” section may include a maximum number of claims the claim manager can be assigned, a current number of claims assigned, and any unavailable calendar days, as discussed in reference to FIGS. 2-5. The current number of claims assigned may be a read-only value based on a runtime query and the unavailable days calendar allows the claim manager to be removed from auto assignment for various days that the claim manager is unavailable. The “Capability Items” section defines all the various capabilities for a particular claim manager across companies, products, and other segmentations. In some instances, a claim manager may be only assigned to one team at a time.

In FIG. 9C, a screenshot showing the runtime processing order across all companies is provided. In certain embodiments, the rules listed in the “Assignment Process Order Rules” box on this page are processed in sequence, allowing processing to cease on the first rule that passes with a claim manager that may be assigned the claim. In some cases, if more than one claim manager is available, the claim will be assigned to an individual in this list based on the max claims and current workload of the available claim managers. Each rule can contain one or more compare fields based on the complexity of the rule. The Load Balancing Engine 106 (see FIG. 1) performs a weighting analysis by comparing ail compare fields in the rule against the values in the claim, as stored as metadata in Database 114 (see FIG. 1). If all compares are true and at least one claim manager has all the capabilities (stored as elements of metadata) listed (as being required to efficiently process the claim), the claim will be assigned by this rule. In the “Compare Field” section, the “Company” field allows for setting a company specific rule, the “Condition Operator” is a list of allowed compare types which may include an equal to condition and a not equal to condition, and the “Compare Value” provides the actual comparison result By utilizing the “Compare Field” section, the supervisory claim manager will be able to develop rules that are used by the Load Balancing Engine 106 to automatically assign claims to a specific team member/claim manager.

Underlying the Load Balancing Engine 106 (sec FIG. 1) are rules accessed via the Rules Engine 108 and developed using the setup tool illustrated in FIGS. 9A, 9B and 9C. The rules are software code executed by the server 102 while handling the various claim assignment logic performed by the Assignment Engine 104 and the Load Balancing Engine 106. In certain embodiments, while the logic for determining an assignment may be performed by the Assignment Engine 104 and the Load Balancing Engine 106, the actual assignment of the claim manager is performed by the Action Handler 118. The following section will describe the implementation of the Action Handler 118 and certain generalized functions that may be performed by the Action Handler 118.

### Exemplary Action Handler Implementation

In some embodiments, the system of FIG. 1 has over 250 available actions that may be used. Each of these actions has associated rules that are accessed by the Rules Engine 108 and utilized by the Assignment Engine 104 and Load Balancing Engine 106 in order to perform the various functions required of that action. Each of these rules is user defined, and the software runtime code associated with the, action utilizing the rule is auto-generated by the Action Handler 118. An example of one of these actions would be the collection of rules associated with the functions performed by the Load Balancing Engine 106.

The Action Handler 118 functions by a user, such as a supervisory claim manager, specifying actions to be performed and, a trigger event indicating when those actions should be performed. When a supervisory claim manager requests the ability to perform actions such as load balancing, requirements for performing such processing are created, and an event specified by a point in time is indicated signifying when the requested action developed by the Action Handler 118 is executed. For example, a trigger event indicating the point in time may be a time when a claim is saved in a storage medium, such as Database 114.

Once an action is requested, the Action Handler 118 develops the code for that new action. The goal of the Action Handler 118 is to create actual code required for the action. The actual code is then populated with decorators and tags to make the code searchable. For example, source code can be created in any programming language that produces an intermediate language (IL) code into a DLL. Microsoft® languages such as C# and visual basic net are examples of programming languages that the Action Handler 118 may use; however, any other programming language may also be used. After creation of the source code the Action Handler 118 compiles that code into a DLL and then catalogs the action defined in the code such that the rest of the server 102 components such as the Assignment Engine 104, Load Balancing Engine 106 and Rules Engine 108, may access the DLL for having the Action Handler 118 perform the action.

After creation of the DLL performing the specified action, it may be further edited by using an Action Template editor. The Action Template editor is a tool that accesses the DLL and can be used to reverse engineer functions and names used in the original source code compiled into the DLL. The Action Template editor allows the developer to manage functionality, for example, to locate and search for DLL's for uncatalogued actions, associate the action to a system trigger, associate registered fields to a parameter of the action, and as all code required to interface the rules engine and metadata and commands to physical code and data at runtime.

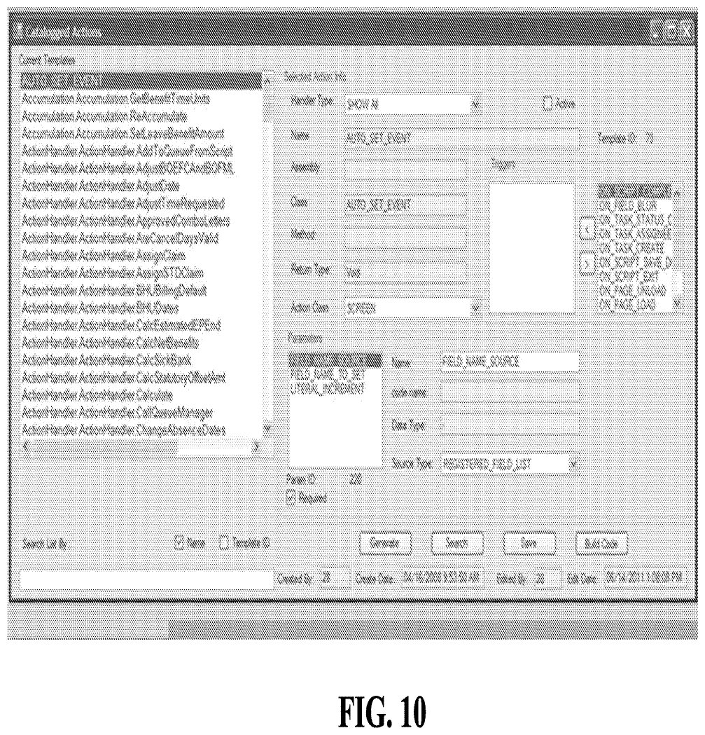

FIG. 10 provides a sample screenshot of an Action Template tool to manage catalogued actions. The “Current Templates” section provides a list of currently defined action handlers. In the illustrated embodiment, the action handlers are named in a format with three sections separated with dots, thus showing [Assemble.NameSpace.Method]. This naming convention is not required, as other methods of naming the various action handlers may be utilized. The “Selected Action Info” section provides a general mapping of data to action. The “Triggers” box associates the selected action to one or more triggers/events. The one or more triggers are used by a rules engine to ensure logical actions for a point in time. The “Generate” button validates setup of all defined actions to ensure that a complete auto code file can be generated. The “Search” button takes a user to a screen used to search DLLs for a searched action. The “Build Code” button builds C# source files that contain all required runtime interfacing code. The “Template ID” code on the top provides a physical key into a set of database definitions and functions such that the generated code is indexed and can subsequently be found in the database.

In the illustrated embodiment, the “Generate” button is utilized such that after using the Action Template and selecting the “Generate” button, an auto-generated cede is provided. The auto-generated code contains all the runtime logic to instruct the back-end action, such as the aforementioned assignment of the claim manager by the Action Handler 118 (see FIG. 1). In some instances, the auto-generated code has a first section that is a header, a second section that lists required libraries, a third section that lists classes, and a fourth section that uses the classes of the third section to build objects.

After creation of action handlers and auto generating the code that specifies the actions to be taken, the action handlers may be connected to time code using a tool known as a Rule Editor. The Rule Editor is abstracted from the physical runtime code via metadata and catalogued data. When a developer or supervisory claim manager needs to create rules for an event, they need only supply the event type and the rule manager handles all processing related to setup including providing context related metadata related to the event, providing context related actions related to the event, and saving the rules or saving versions of the rules.

Tokens may be used to better manage communication between multiple applications. A token is returned that can be used to execute the code at runtime or edit the rules in the future. A dedicated token management program may be responsible for token management. Multiple tokens may he created for an event, for example, a unique set of rules may be created for multiple companies for a single event. All event metadata management is controlled by the DDM 110 (see FIG. 1) component which maps metadata to a physical database location.

The Rules Engine 108 (see FIG. 1) provides the user with a common interface that allows the user to create system flow using metadata and existing physical code, that is, the action handlers. The metadata and actions available are presented in the context of an event. All functionality presented in the user interface executes at run-time because of this context control. Functionalities include, “If Current Employee Work State’ is ‘Maine’ then ‘Create Task’ ‘Get Required Maine Details.’”. In this example, “Current Employee Work State” would be a registered field, “Current Task” would be an action handler, “Get Required Maine Details” would be a parameter to the action, and “Maine” is from a lookup based on the metadata field.

The Rules Engine 108 knows the proper metadata items to present based on the key guaranteed to the event via the DDM 110. The Rules Engine 108 further knows the states related to “Current Employee Work State” because metadata can have associated reference data. The “Get Required Maine Details” may be a defined and required parameter for this action handler.

Action Handler 118 (see FIG. 1) relies on several runtime components. An Action Manager tool is a reusable component that manages all aspects related to using the auto-generated code. All requests to use action handler methods are channeled through this manager. The manager is responsible for loading all assemblies required by an action handler, creating the instances of the Action Handler 118 dispatch dictionary, thread locking related to obtaining a dictionary instance, and contains methods to translate data required by the action handlers. The dispatch dictionary reads the definition of the action handler name and transforms that definition into actual physical code that performs the function of the action handler.

The DDM 110 is another component relied upon by Action Handler 118 and is already explained above. In some embodiments, as additional metadata is obtained by the DDM 110, the auto generated code is updated at runtime. The Rules Engine 108, already described, allows for reading rules, gathering live data based on the actual metadata items used, by the rule set, execute the rules against live data, create a list of actions to perform, and execute the actions using the generated code. In this manner, the Rules Engine 108 is able to access and run rules performing actions set up and modified via the Action Handler 118.

### System and Process Overview

Embodiments of the disclosure provide a system and process for building a team of claim managers responsible for processing insurance claims from subscribers to a Disability Insurance Cartier 116. Further, the system and process is capable of collecting data related to the insurance claims and automatically assigning a suitable claim manager to process the insurance claim in order to help the subscriber reach an expeditious and efficient conclusion to the insurance claim. In order to achieve this expeditious and efficient conclusion to the claim, the system allows the assigned claim manager to more efficiently interact with the subscriber to process the claim. This efficiency is realized by defined capabilities of that claim manager that are stored in the system and which allow the claim manager to make decisions regarding the insurance claim efficiently. Further, the claim manager can update data stored regarding the insurance claim which will cause the system to automatically escalate the claim to a higher authority claim manager or supervisor if the insurance claim needs such higher authority. In so doing, the insurance claim will be processed quickly as opposed to a process where the claim manager must manually engage the higher authority.

In order to have the automatic assignment of claim managers, as discussed above, claim manager teams and capabilities of each claim manager of the team must be specified. As new insurance claims are provided to the Disability Insurance Carrier 116 (see FIG. 1), an application performed by the server 102 utilizes these claim manager teams and the capabilities of each claim manager to make an assignment of that insurance claim to a selected claim manager. Once the assignment is made, the claim manager will provide updates to the system such that the application running at the server 102 will be able to further process that insurance claim is an efficient manner.

In order to build the team of claim managers and specify capabilities, the system provides the User Interface 120 (see FIG. 1) The User Interface 120 includes a variety of specific interfaces, as discussed with respect to FIGS. 2-5. One such interface is the team configuration interface illustrated in FIG. 2. From this interface, claim managers can be added to the team of claim managers.

Another interface is the claim manager capability assignment interface illustrated in FIG. 3. From this interface, various capabilities of a certain chosen claim manager from the team of claim managers can be specified. These capabilities are stored in the Database 114 (see FIG. 1) for each claim manager as assigned medical conditions that are representative of medical conditions an individual claim manager is assigned for treating. In certain embodiments, the assigned medical conditions are converted to elements of metadata by the User Interface 120 and stored in the Database 114 as claim manager capability metadata.

A further interface is the claim assignment data interface illustrated in FIG. 4. From this interface, a maximum number of assigned claims and type of claim can be assigned to the selected claim manager from the, team of claim managers. In this manner, the work load of certain claim managers can be limited.

The claim assignment data interface further includes a “Last Claim Assigned Date” that provides the time of last assignment, which is a date on which the selected claim manager was last assigned a disability claim. In certain embodiments, a new disability claim assignment is based on which of a list of claim managers determined to be capable of processing the new disability claim was assigned a disability claim the farthest back in time. In this manner, the list of claim managers determined to be capable of processing the new disability claim form a sort of assignment line where the claim manager assigned an insurance claim the farthest hack in time is at the front of the line for the next assignment.

Yet another interface is the benefit authority interface illustrated in FIG. 5. From this interface, a maximum benefit authority for each claim manager of the team of claim managers can be specified. In this manner, limitations can be placed on a claim manager for how much that claim manager can approve in benefits before having to seek the approval of a higher authority. Further, a level of detail is provided such that a maximum benefit authority can be specified for a multitude of types of claims.

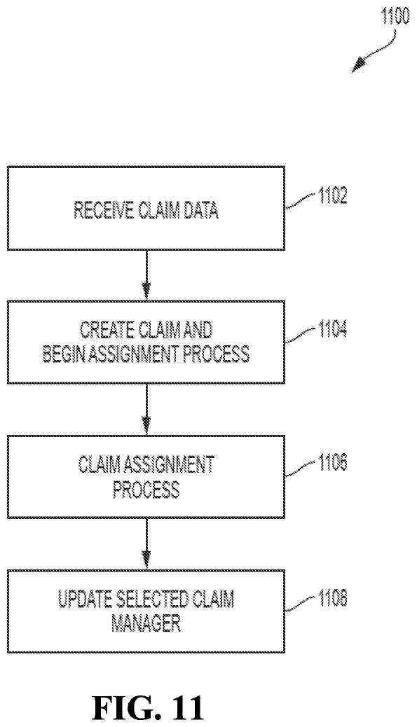

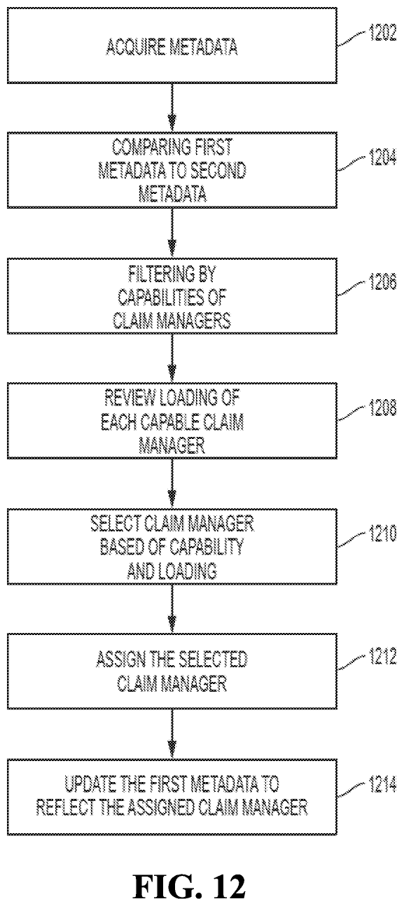

Once a team of claim managers has been set up, the system is utilized to automatically assign a claim manager to new insurance claims as the claims are provided to the Disability Insurance Carrier 116 (see FIG. 1). A process flow for the claim assignment process is provided in FIGS. 11 and 12. FIG. 11 illustrates a high level overall process flow 1100. At step 1102, claim data, such as medical condition data, related to an insurance claim from a subscriber is received at an interface of the Disability Insurance Carder 116 and collected by the Script Engine Intake 112. At step 1104, the Script Engine Intake 112 creates the insurance claim in the system by converting the claim data into first elements of first metadata and storing the first elements of the first metadata in the Database 114. Once the first elements of the first metadata is stored, the Script Engine Intake 112 starts the process of assigning a claim manager by notifying the Assignment Engine 10 of the new insurance claim. At step 1106, the Assignment Engine 104 performs the claim assignment process. At step 1108, a claim manager has been selected to process the insurance claim, and the selection is provided to the Action Handler 118 to notify the claim manager of the assignment by updating the first metadata stored in the Database 114 for the insurance claim.

FIG. 12 illustrates a more detailed process flow of steps 1106 and 1108 from FIG. 11. After the Assignment Engine 104 (see FIG. 1) is notified of the insurance claim, at step 1202, the Assignment Engine 104 acquires the first elements of the first metadata stored in the Database 114 via the Dynamic Data Manager 110. Based on the acquired first elements of the first metadata, the Assignment Engine 104 determines a team of claim managers that are capable of processing this claim. In certain embodiments, the first step in this determination is comparing, the first elements of the first metadata to second elements of second metadata that represents assigned medical conditions each claim manager of the team of claim managers are assigned to handle, at step 1204. The second elements are organized on a per claim manager basis such that each claim manager has a set of second elements that are entered via the User Interface 120 collectively stored for the totality of claim managers in the Database 114 as the second metadata.

At step 1206, the Assignment Engine 104, based on the comparison in step 1204, filters out claim managers that do not have capabilities suitable for processing the insurance claim. This filtering performs a weighting analysis that looks for a match between the first elements of the first metadata which describes features of the disability claim, such as age or insured, type of medical condition (addiction, pregnancy, MS, etc.) and any other data related, to the medical claim with the second elements of the second metadata that represent assigned medical conditions data of the team of claim managers. In certain embodiments, the weighting analysis begins by reviewing each the first elements of the disability claim in the first metadata to determine if a china manager exists that has experience with each of the first elements. Specifically, the Assignment Engine 104 compares the first elements against the second elements for each of the claim managers to determine whether one or more claim managers have the first elements (medical conditions data) in common with the second elements defining their assigned capabilities. If no claim manager has that particular combination of experience, then the weighting analysis begins to back out certain features (individual first elements) in order to perform a less detailed search for a d aim manager with the appropriate experience. The weighting analysis continues in this manner until at least one suitable claim manager is found.

At step 1208, the Load Balancing Engine 100 reviews the loading of each claim manager not filtered out in step 1206 to determine one or more of a time of last assignment for each remaining claim manager and/or a number of currently active claims being processed by each remaining claim manager. At step 1210, the Load Balancing Engine 106 selects the claim manager with the time of last assignment that is farthest back in time and/or the claim manager with the fewest active claims assigned, and at step 1212 assigns the claim to the selected claim manager. This represents a last in first out (LIFO) process. The assignment is made at step 1214 by the Action Handler 118 updating metadata for the insurance claim stored in Database 114 via the Dynamic Data Manager 110. The metadata is updated to reflect a claim owner, which is the selected claim manager. This claim manager then has responsibility for this insurance claim and will provide updates to the system such that the claim is processed in an efficient manner.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term at least one followed, by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can he performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A graphical user interface executed by at least one server for configuring a team of claim managers suitable for processing disability claims for a disability insurance carrier, the user interface comprising:
a team configuration interface configured to allow a user to add one or more claim managers to the team of claim managers or remove the one or more claim managers from the team of claim managers;
a claim manager capability assignment interface configured to allow a user to specify capabilities of a selected claim manager from the team of claim managers;
a claim assignment data interface configured to allow a user to specify an amount and type of insurance claims assigned to the selected claim manager from the team of claim managers; and
a benefit authority interface configured to allow a user to specify limitations on a monetary amount in benefits the selected claim manager can approve.

2. The graphical user interface of claim 1, wherein the team configuration interface, the claim manager capability assignment interface, the claim assignment data interface and the benefit authority interface are only accessible to a supervisory claim manager responsible for managing the team of claim managers.

3. The graphical user interface of claim 1, wherein the team configuration interface comprises an add button and a remove button, the add button configures the user interface to add, the one or more claim managers to the team of claim managers and the remove button configures the user interface to remove the one or more claim managers from, the team of claim managers.

4. The graphical user interface of claim 1, wherein the team configuration if displays a number of insurance claims assigned to each claim manager in the team of claim managers.

5. The graphical user interface of claim 1, wherein the claim manager capability assignment interface comprises a capability type drop down box that specifies a specific capability and a value drop down box that specifies a value of the specific capability.

6. The graphical user interface of claim 5, wherein the claim manager capability assignment interface comprises an add capability button and a remove selected button, wherein the add capability button configures the claim manager capability assignment interface to add the specific capability selected in the drop down box and the value of the specific capability in the value drop down box as one of the capabilities of the selected claim manager.

7. The graphical user interface of claim 1, wherein the claim assignment data interface comprises a max claims allowed data entry box and a save max allowed button, wherein a maximum, number of claims the selected claim manager is allowed to be assigned is specified in the max claim allowed data entry box and saved as an attribute of the selected claim manager when the save max allowed button is actuated.

8. The graphical user interface of claim 1, wherein the claim assignment data interface comprises an unavailable days box that specifies dates the selected claim manager is unavailable to be assigned an insurance claim.

9. The graphical user interface of claim 1, wherein the benefit authority interface includes a data entry box for entry of the monetary amount and an update capability limits button, and wherein when the updating capability limits button is actuated, the monetary amount entered into the data entry box is stored as a limitation for the monetary amount in benefits the selected claim manager can approve.

10. The graphical user interface of claim 1, further comprising an assignment process management interface configured to allow a user to specify compare field criteria to be used to develop one or more claim manager assignment rules to be used to assign a specific disability claim to a specific claim manager.

11. The graphical user interface of claim 10, wherein the assignment process management interface is further configured to allow a user to change the order in which a plurality of the claim manager assignment rules will be processed in order to assign the specific disability claim to the specific claim manager.

12. The graphical user interface of claim 1, further comprising:
an action handler interface configured to allow a user to specify a trigger event for the automatic performance of a claim management actions

13. A graphical user interface executed by at least one server for automatically selecting individual claim managers to process disability claims, the user interface comprising:
an assignment process management interface configured to display one or more claim manager assignment rules to be processed for automatically selecting an individual claim manager to be assigned a specific disability claim;
the assignment process management interface further configured to allow a user to specify a compare field criteria to be used to develop an additional claim manager assignment rule, and
the assignment process management interface further configured to allow a user to add the additional claim manager assignment rule to the displayed claim manager assignment rules.

14. The graphical user interface of claim 13, wherein the assignment process management interface is further configured to specify the order in which the displayed claim manager assignment rules will be processed.

15. The graphical user interface of claim 13, wherein the assignment process management interface is further configured to allow a user to change the order in which the displayed claim manager assignment rules will be processed.

16. The graphical user interface of claim 13, wherein the assignment process management interface comprises a menu with a plurality of selectable compare field criteria to be used to develop the additional claim manager assignment rule.

17. The graphical user interface of claim 16, wherein the assignment process management interface is further configured to allow a user to a add or remove selectable compare field criteria.

18. The graphical user interface of claim 16, wherein at least one of the selectable compare field criteria is based on the availability of claim managers.

19. The graphical user interface of claim 13, further comprising:
a team configuration interface configured to allow a user to add or remove one, or more claim managers to a team of claim managers; and
a claim manager capability assignment interface configured to allow a user to specify capabilities of a selected claim manager from the team of claim managers.

20. The graphical user interface of claim 13, further comprising:
a claim assignment data interface configured to allow a user to specify an amount and type of insurance claims assigned to the selected claim manager from a team of claim managers; and
a benefit authority interface configured to allow a user to specify limitations on a monetary amount in benefits the selected claim manager can approve.
